(19) United States
(12) Patent Application Publication
(10) Pub. No.: US 2018/0035795 A1
(43) Pub. Date: Feb. 8, 2018

(54) G-SHAPE ERGONOMIC T-SHIRT BAG HANDLE

(71) Applicant: Bernard Cloutier, Vancouver (CA)

(72) Inventor: Bernard Cloutier, Vancouver (CA)

(73) Assignee: Bernard Cloutier, Vancouver (CA)

(21) Appl. No.: 15/630,993

(22) Filed: Jun. 23, 2017

(30) Foreign Application Priority Data
May 15, 2017 (CA) 2967227

(51) Int. Cl. A45F 5/10

(52) U.S. Cl. CPC A45F 5/1046; A45F 2005/1073; B29L 2031/463

(57) ABSTRACT

This invention is an ergonomic hand held, tubular object which provides an improved means of gripping shopping bag handles.

This invention advantageously provides an improved means of gripping shopping bag handles in a comfortable and convenient fashion, whether the shopping bags be made of plastic or other similar materials, bio-degradable or not, particularly the types commonly referred to as the T-Shirt Bags and Reusable Bags.

### BACKGROUND OF THE INVENTION

Ever since plastic T-Shirt bags have been introduced in the retail environment during the 1960's, inventors have tried to design and market inventions to address the discomforts and inconveniences associated with the hand carrying of T-Shirt bags, particularly, bags made of plastic or other similar materials, bio-degradable or not. To my knowledge, no invention has had any success in the market place as of today.

A study of prior art and patents reveals that inventions were generally of the following types.
1) Variations of a long piece of material of some sort with various types of bag fasteners at both ends. Ex: CA 2519069 Moses & al.,
2) Variations of a hollow tubular object with various means of fastening shopping bags to them, including, dents, longitudinal slits, and even a spiraling slit such as U.S. Pat. No. 5,199,758 Howell 1993/04.
3) Variations of a flat, flexible sheet concept to wrap around bag handles with various means of securing the contraption together such as in U.S. Pat. No. 7,819,449 Johnson 2010/10.
4) Variations of handles with some sort of hook incorporated to it such as U.S. Pat. No. 5,181,757 Montoya 1993/01.

Patents listed below are representative of these 4 types of inventions.

| | | |
|---|---|---|
| U.S. Pat. No. 6,499,781 | Flynn | 2002 December |
| U.S. Pat. No. 7,024,730 | Scholes | 2006 April |
| U.S. Pat. No. 5,181,757 | Montoya | 1993 January |
| U.S. Pat. No. 9,326,588 | Jones | 2016 May |
| U.S. Pat. No. 7,819,449 | Johnson | 2010 October |
| U.S. Pat. No. 5,005,891 | Lunsford | 1991 April |
| U.S. Pat. No. 7,328,925 | Jenkins | 2008 February |
| U.S. Pat. No. 5,026,105 | Feldman | 1991 June |
| U.S. Pat. No. 8,020,910 | Startzell | 2011 September |
| U.S. Pat. No. 5,150,938 | Gans | 1992 September |
| U.S. Pat. No. 5,029,926 | Dieterich Jr | 1991 July |
| U.S. Pat. No. 3,913,172 | Richards' | 1975 October |
| U.S. Pat. No. 5,992,803 | Leroux | 1999 November |
| Ca 2,410,765 | Wowk | *No patent issued |
| Ca 2,519,069 | Moses & al. | *No patent issued |
| U.S. Pat. No. 5,722,117 | Nielsen | 1998 March |
| U.S. Pat. No. 4,846,519 | Wesley | 1989 July |
| U.S. Pat. No. 4,590,640 | Emersen | 1986 May |
| U.S. Pat. No. 7,387,324 | Sharpe | 2008 June |
| U.S. Pat. No. 4,890,355 | Schulten | 1990 January |
| U.S. Pat. No. 5,199,758 | Howell | 1993 April |

Though many inventions have been patented none have achieved significant or noticeable commercial success and/or popularity. The pain point for the shoppers remains and so does the need for a better solution.

### SUMMARY OF THE INVENTION

Considered broadly, it is known that bags come in two main varieties. One variety has no handles and the other variety has two handles that extend from opposite sides with which one's hand can grip the bag to carry it. The later variety is commonly referred to as T-Shirt bags because of their design similarities with T-Shirts. It is known that retailers often offer bags to shoppers at Point of Sale (POS) that are of this later variety commonly referred to as T-Shirt bags.

Shoppers frustrations associated with the now ubiquitous T-Shirt bags are commonly known;
1. Discomfort and sometimes excruciating pain associated with the T-Shirt bag's content weight, narrowly localized, sharp and cutting downward pull on the hand.
2. Inconvenience of having to repack one or multiple T-Shirt bags after their contents have spilled out while temporarily resting on a counter, floor, car seat or other surfaces, outside the grip of one's hand.
3. Inconvenience of having to regroup and pick up one, or multiple loose T-Shirt bags after being temporarily resting on a counter, floor or other surfaces, outside the grip of one's hand.

In this invention, an ergonomic, hand held, tubular object provides an improved means of comfortably gripping T-Shirt bag handles that effectively addresses those inconveniences and frustrations by allowing T-Shirt bag handles to be easily and quickly inserted deep inside the invention thereby trapping the T-Shirt bag handles inside the invention until released by a simple, quick and easy, partial rotation of the invention while pulling upward.

Advantageously, the invention makes the activity of hand carrying T-Shirt bags more comfortable and more convenient because;
1. It serves as protection against discomforts associated with the T-Shirt bag's content weight, narrowly localized, sharp and cutting downward pull on the hands of the shopper, because it dynamically redistributes the T-Shirt bag's load weight on a large area of the hand.
2. Once inside the invention, the handles of one or multiple T-Shirt bags remain trapped together inside the invention until unpacking thereby in effect, being secured and bundled together.
4. One or more T-Shirt bags can remain closed, as a result of being secured and bundled together by their handles, preventing them to tip over and spill out their contents, as is often the case when outside the grip of one's hand while temporarily lying on a counter, floor, car seat or other surfaces.
5. One or more T-Shirt bags can be quickly picked up from an easily reachable handle, as a result of being secured and bundled together in the invention by their handles; an otherwise tricky operation when loose T-Shirt bags are in a precarious and unstable situation outside the grip of one's hand, while temporarily on a counter, floor, car seat or other surfaces.
6. Once ready to unpack the T-Shirt bags, a shopper can quickly and easily release the bag handles from the invention by executing a simple quarter turn rotational movement of the invention while pulling it up slightly.

In the drawings which form a part of this specification of the invention,

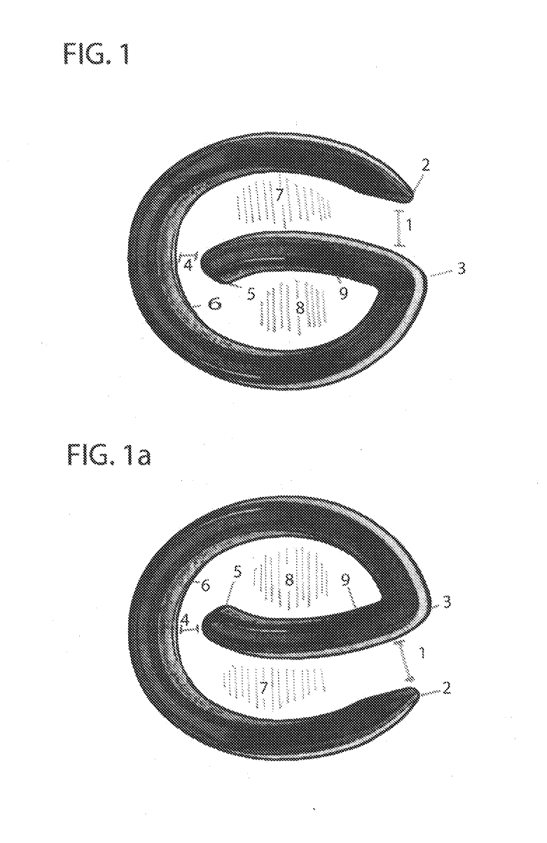

FIG. 1 is a front view of the invention profile.

FIG. 1a is a back view of the invention profile shown in FIG. 1.

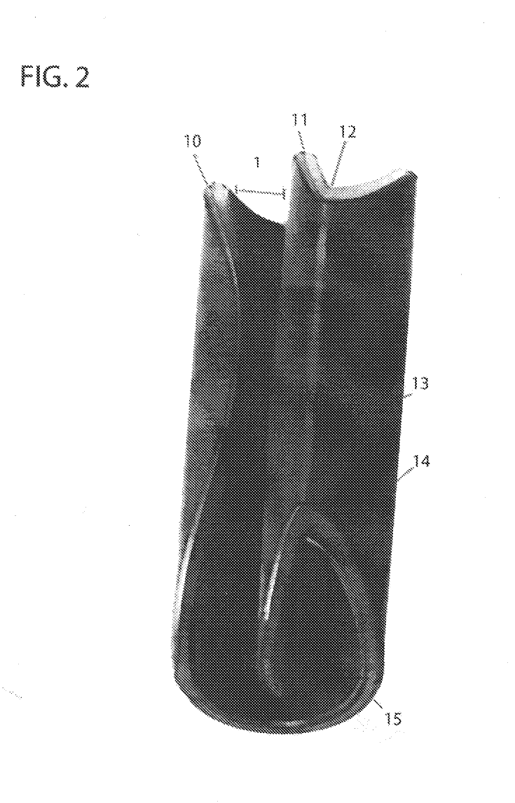

FIG. 2 is a perspective view of the invention.

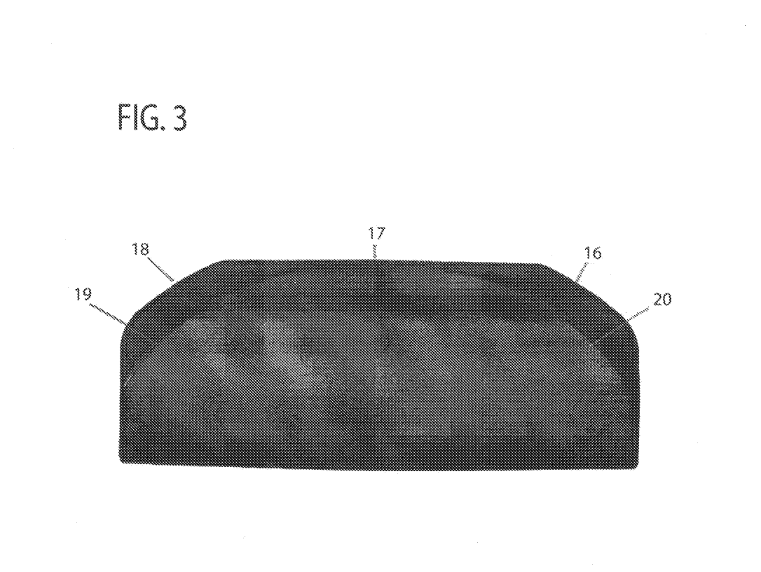

FIG. 3 is a top-side view of the invention.

### DETAILED DESCRIPTION OF THE INVENTION

This invention relates to a hand-held object to grip T-Shirt bag handles with.

This invention builds on the opportunities for improvement of prior art and inventions with regards to comfort and convenience such that; it is compact enough to be commonly, comfortably and easily carried around in a purse or in various garment pockets, its ergonomic features provide comfortable and efficient deflection of the sometime sharp and cutting T-Shirt bag handle pressure, and finally, that it allows to simply, quickly and easily trap together into the invention the T-Shirt bags handles or just as easily un-trap the T-Shirt bags handles out of the invention.

I have found that the drawbacks or inconveniences, of previous inventions could be overcome by creating an ergonomic hand held, hollow, open ended, elongated G-shape profiled object with narrow slits extending lengthwise that provides an improved means of gripping T-Shirt bags handles.

The invention is made by injection molding of rigid polymeric material with a two mirror-part, multiple cavity injection tool, although a variety of rigid or semi-rigid injectable material could be used to attain the functionality goals of the invention.

The following is a comprehensive description of the invention with details about how it meets the characteristics and functionality desired by shoppers:

FIG. 1 shows a profile view of the invention ergonomic tubular structure, a wall section 9 projecting inwardly from a point 3 on the invention exterior surface, dividing the invention in two elongated, open-ended hollow sections. One hollow section 7 with an outside slit opening 1 between 2 and 3, and the other hollow section 8 with an interior slit opening 4 between 5 and 6, interconnecting the two sections 7 and 8.

FIG. 1a shows the profile view of FIG. 1 pivoted 180 degrees on the horizontal axis. Everything stays the same but now the profile that generally looked like G-shape in FIG. 1 now generally looks like an e-shape in FIG. 1a. This is the same invention seen from a different view.

This profile structure allows for T-Shirt bag handles to be easily and quickly inserted deep into the invention by sliding them through the outside slit opening 1 of hollow section 7 and then through the interior slit opening 4 of hollow section 8, this with a natural slide along the smooth inside surfaces of the invention. Once deep inside hollow section 8, bag handles are trapped together inside the invention until un-trapped and released out of the invention by a quick and easy quarter turn rotation of the invention while pulling on it upwardly.

FIG. 2 shows a perspective view of an ergonomic hand held, tubular object with two narrow slits extending lengthwise. The outside slit opening 1 is visible in its entirety. The shoulder 10 of the top hollow section is slightly recessed from the shoulder 11 of the bottom hollow section. All features of the invention are symmetrical on both side of middle line 13. Thickness of the material is at maximum in the middle at line 13 and decreasing imperceptibly toward both extremities at 15 and 11 with a 1% tapering to accommodate requirements of injection molding. The surface 14 of the invention is smooth and all edges as shown in 15, 10 and 11 are smooth fileted. The notches 12 created on both extremities of the invention add effectiveness to the trap by catching bag handles when a t-shirt bag bundle is temporarily placed on a surface.

FIG. 3 shows a top-side view of the invention. In this perspective, it is clearly visible that on the side of the outside slit opening 17, both ends of the invention are modified 18, 19 and 16, 20 as if one side of the invention was constrained by two concentric and, invisible, overlapping elliptical shapes, one larger limiting the bottom hollow section ends 18 and 16 and a concentric, smaller, second invisible elliptical shape limiting the top hollow section ends 19 and 20 in a recessed fashion from the bottom hollow section.

This feature adds to the functionality of the invention as it facilitates the insertion of T-shirt bag handles inside it through the outside slit opening. When one holds the invention while attempting to insert T-Shirt bag handles into it, they will tend to naturally fall onto the inward middle section ledge created by the recessed top side extremities.

This feature also adds to the ergonomic sensation of the invention that makes it intrinsically comfortable for carrying T-Shirt bags. Rounded extremities 18, 19 and 16, 20 provide comfortable rest area and support for the hand palm and thumb.

The embodiments of the invention in which an exclusive property or privilege is claimed are defined as follows:

1) A tubular object comprising:
a. a rounded wall section defining the exterior surface of the invention;
b. a wall section projecting inwardly from the rounded wall of the invention dividing the interior of the invention in two elongated, open-ended hollow sections;
c. an outside slit opening in the rounded wall section, extending length wise, along one side of the inwardly projecting wall section; and
d. an interior slit opening between the rounded wall section of the invention and the inside end of the inwardly projecting wall section, extending length wise, alongside the interior surface of the rounded wall section of the invention, interconnecting the two adjacent, elongated, open-ended, hollow sections;
wherein the T-Shirt bag handles can be inserted in one of the two elongated, open-ended hollow sections of the invention through the outside slit opening and forced to slide into the other hollow section of the invention through the interior slit opening by a partial rotation of the hand, thereby becoming trapped until un-trapped and released from the invention by an inverse partial rotation of the hand while pulling upward.

2) A method of trapping the handles of one or more T-Shirt bags inside the invention comprising the steps of:
a. holding the invention in hand with the outside slit opening facing up and away from inside the hand;
b. inserting T-Shirt bag handles in one of the invention's elongated, open-ended hollow section through the outside slit opening;
c. sliding T-Shirt bag handles through the interior slit opening into the adjacent and interconnected, elongated, open-ended, hollow section; and
d. performing a partial rotation of the invention, counter clockwise if the invention is held with the left hand, or clockwise if the invention is held with the right hand, while pulling upward, such as to force all the T-Shirt bag handles against the inside wall of the invention at the innermost point of this elongated, open-ended hollow section where they become trapped-in.

3) A method of un-trapping and releasing the handles of one or more T-Shirt bags from inside the invention, comprising the steps of:
a. holding the invention in hand with the outside slit opening facing up and away from inside the hand; and
b. performing a partial rotation of the invention, clockwise if the invention is held with the left hand or counter clockwise if the invention is held with the right hand, while pulling upward, such as to force all the T-Shirt bag handles away and out from the inside of the invention.
